(19) United States
(12) Patent Application Publication
(10) Pub. No.: US 2014/0009461 A1
(43) Pub. Date: Jan. 9, 2014

(54) Method and Device for Movement of Objects in a Stereoscopic Display

(71) Applicants: Hui Dai, Norhbrook, IL (US); Timothy Dickinson, Crystal Lake, IL (US); John C. Johnson, Spring Grove, IL (US); Seok-Hwan Kim, Seoul (KR); Jeong J. Ma, Long Grove, IL (US); Phillip D. Rasky, Buffalo Grove, IL (US)

(72) Inventors: Hui Dai, Norhbrook, IL (US); Timothy Dickinson, Crystal Lake, IL (US); John C. Johnson, Spring Grove, IL (US); Seok-Hwan Kim, Seoul (KR); Jeong J. Ma, Long Grove, IL (US); Phillip D. Rasky, Buffalo Grove, IL (US)

(73) Assignee: Motorola Mobility LLC, Libertyville, IL (US)

(21) Appl. No.: 13/543,397

(22) Filed: Jul. 6, 2012

(51) Int. Cl. G06T 15/00

(52) U.S. Cl. 345/419

(57) ABSTRACT

Disclosed is a method of manipulating viewable objects that includes providing a touch screen display capable of stereoscopic displaying of object images, wherein a zero-plane reference is positioned substantially coincident with the physical surface of the display, displaying on the touch screen a first object image and one or more second object images, wherein the object images are displayed to appear at least one of in front of, at, or behind the zero-plane, receiving a first input at the touch screen at a location substantially corresponding to an apparent position of the first object image, and modifying the displaying on the touch screen so that at least one of the first object image and the one or more second object images appear to move towards one of outward in front of the touch screen or inward behind the touch screen in a stereoscopic manner.

### FIELD OF THE INVENTION

The method and system encompassed herein is related generally to the interactive display of images on a device display and, more particularly, to the interactive display of object images in a stereoscopic manner.

### BACKGROUND OF THE INVENTION

As technology has progressed, various devices have been configured to display images, and particularly objects in those images, in a manner by which users perceiving those object images perceive the object images to be three-dimensional (3D) object images, even though the images are displayed from two-dimensional (2D) display screens. Such manner of display is often referred to as stereoscopic or three-dimensional imaging. Stereoscopic imaging is a depth illusion created by displaying a pair of offset images separately to right and left eyes of a viewer, wherein the brain combines the images to provide the illusion of depth. Although the use of stereoscopic imaging has enhanced the ability of engineers, artist designers, and draftspersons to prepare perceived 3D type models, improved methods of manipulating the objects shown in a perceived 3D environment are needed.

### BRIEF SUMMARY

The above considerations, and others, are addressed by the method and system encompassed herein, which can be understood by referring to the specification, drawings, and claims. According to aspects of the method and system encompassed herein, a method of manipulating viewable objects is provided that includes providing a touch screen display capable of stereoscopic displaying of object images, wherein a zero-plane reference is positioned substantially coincident with the physical surface of the display, displaying on the touch screen a first object image and one or more second object images, wherein the object images are displayed to appear at least one of in front of, at, or behind the zero-plane. The method further includes receiving a first input at the touch screen at a location substantially corresponding to an apparent position of the first object image, and modifying the displaying on the touch screen so that at least one of the first object image and the one or more second object images appear to move towards one of outward in front of the touch screen or inward behind the touch screen in a stereoscopic manner.

According to further aspects, a method of manipulating viewable objects displayed on a touch screen is provided that includes displaying a first object image and one or more second object images in a perceived virtual space provided by a touch screen display configured to provide a stereoscopic display of the first object image and one or more second object images. The method further includes positioning the first object image at or adjacent to a zero-plane that intersects the virtual space and is substantially coincident with the surface of the touch screen display, sensing a selection of the first object image, and modifying the perceived position of at least one of the first object image and the one or more second object images, such that at least one of the first object image and the one or more second object images are relocated to appear a distance from their original displayed location.

According to still further aspects, a mobile device is provided that includes a touch display screen capable of providing a stereoscopic view of a plurality of object images, wherein the object images are configured to appear to a user viewing the display to be situated in a three-dimensional virtual space that includes a world coordinate system and a camera coordinate system, wherein the camera coordinate system includes an X axis, Y axis, and Z axis with a zero-plane coincident with an X-Y plane formed by the X axis and Y axis, and the zero-plane is substantially coincident with the surface of the display screen. The mobile device further including a processor that is programmed to control the display of the plurality of object images on the display screen, wherein at least one of the object images is displayed so as to appear at least partly coincident with the zero plane, such that it is selected by a user for performing a function, and at least one of the other object images appears positioned at least one of inward and outward of the zero plane and is not selected to perform a function.

### BRIEF DESCRIPTION OF THE SEVERAL VIEWS OF THE DRAWINGS

While the appended claims set forth the features of the method and system encompassed herein with particularity, the method and system encompassed herein with its objects and advantages, may be best understood from the following detailed description taken in conjunction with the accompanying drawings of which:

FIG. 1 depicts an example mobile device;

FIG. 2 depicts an example block diagram showing example internal hardware components of the mobile device of FIG. 1;

FIG. 3 depicts an example schematic diagram that illustrates a virtual space that includes an example stereoscopic display of example object images arranged in relation to X, Y, and Z axes of the virtual space;

FIG. 4 depicts an example cross-sectional view of FIG. 3 taken along the X-Z plane of FIG. 3;

FIG. 5 depicts an example user display screen view of the display screen of the mobile device;

FIG. 6 depicts an example modified view of FIG. 4 that illustrates the position of the object images in the X-Z plane of the virtual space, after a user has selected the primary object image for a period of time;

FIG. 7 depicts an example view of the components in FIG. 6 after a push manipulation by a user;

FIG. 8 depicts an example view of the components in FIG. 7 illustrating the object images in a new position, after a user has ceased the push manipulation;

FIG. 9 depicts an example display screen view as seen by a user (that is, a view similar to that of FIG. 5), of the configuration shown in FIG. 8;

FIG. 10 depicts an example view of the components in FIG. 6 after a pull manipulation by a user;

FIG. 11 depicts an example view of the components in FIG. 10 illustrating the object images in a new position, after a user has ceased the pull manipulation; and

FIG. 12 depicts an example display screen view as seen by a user, of the configuration shown in FIG. 11.

### DETAILED DESCRIPTION

Turning to the drawings, wherein like reference numerals refer to like elements, the method and system encompassed herein is illustrated as being implemented in a suitable environment. The following description is based on embodiments of the method and system encompassed herein and should not be taken as limiting with regard to alternative embodiments that are not explicitly described herein.

As will be described in greater detail below, it would be desirable if an arrangement of multiple object images with respect to which user interaction is desired could be displayed on a mobile device in a stereoscopic manner. Further, it would be desirable to display objects in a stereoscopic manner such that their manipulation is intuitive to a user and they provide a realistic stereoscopic appearance before, during, and after manipulation. The display and manipulation of such object images in a stereoscopic environment can be presented in numerous forms. In at least some embodiments, the object images are displayed and manipulated on a mobile device, such as a smart phone, a tablet, or a laptop computer. In other embodiments, they can be displayed and manipulated on other devices, such as a desktop computer. The manipulation is, in at least some embodiments, accomplished using a touch sensitive display, such that a user can manipulate the object images with a simple touch, although other types of pointing and selecting devices, such as a mouse, trackball, stylus, pen, etc., can be utilized in addition to or in place of user-based touching.

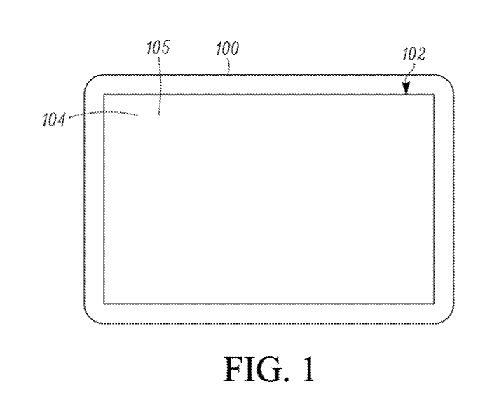

FIG. 1 depicts an example mobile device 100. The mobile device 100 can include, in at least some embodiments, a smart phone (e.g., RAZR MAXX, etc.), a tablet (e.g., Xoom, etc.), or a laptop computer. In other embodiments, the mobile device 100 can include other devices, such as a non-mobile device, for example, a desktop computer that includes a touch-based display screen, or a mechanical input device, such as a mouse. Although various aspects described herein are referenced to a touch-based display screen, it is to be understood that selection of an object image can include human and/or mechanical device touching/selection.

The mobile device 100 in the present embodiment includes a touch screen display screen 102 having a touch-based input surface 104 (e.g., touch sensitive surface or touch panel) situated on the exposed side of the display screen 102, which is accessible to a user. For convenience, references herein to selecting an object at the display screen 102 should be understood to include selection at the touch-based input surface 104. The display screen 102 is in at least some embodiments planar, and establishes a physical plane 105 situated between the exterior and interior of the mobile device 100. In other embodiments, the display screen 102 can include curved portions, and therefore, the physical plane 105 can be non-planar. The display screen 102 can utilize any of a variety of technologies, such as, for example, specific touch sensitive elements. In the present embodiment, the display screen 102 is particularly configured for the stereoscopic presentation of object images (as discussed below). More particularly, the display screen 102 can include an LCD that uses a parallax barrier system to display 3D images, such as manufactured by Sharp Electronics Corp. in New Jersey, USA. The parallax barrier has a series of vertical slits to control the path of light reaching the right and left eyes, thus creating a sense of depth. The part is a whole screen with the regular LCD and a barrier layer sandwiched in between touch and LCD glasses. The display screen 102 displays information output by the mobile device 100, while the input surface 104 allows a user of the mobile device 100, among other things, to select various displayed object images and to manipulate them. The mobile device 100, depending upon the embodiment, can include any of a variety of software configurations, such as an interface application that is configured to allow a user to manipulate the display of media stored on or otherwise accessible by the mobile device 100.

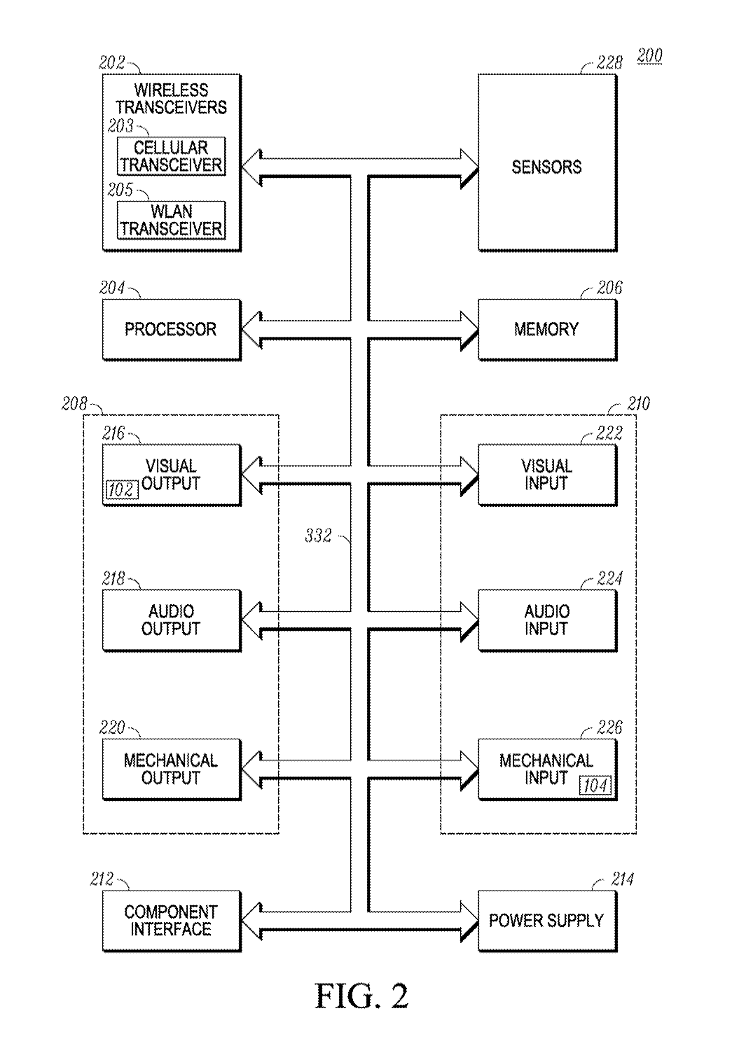

FIG. 2 depicts an example block diagram illustrating example internal components 200 of the mobile device 100. As shown in FIG. 2, the components 200 of the mobile device 100 include multiple wireless transceivers 202, a processor portion 204 (e.g., a microprocessor, microcomputer, application-specific integrated circuit, etc.), a memory portion 206, one or more output devices 208, and one or more input devices 210. In at least some embodiments, a user interface is present that comprises one or more of the output devices 208, and one or more of the input devices 210. Such is the case with the present embodiment, in which the display screen 102 includes both output and input devices. The internal components 200 can further include a component interface 212 to provide a direct connection to auxiliary components or accessories for additional or enhanced functionality. The internal components 200 can also include a power supply 214, such as a battery, for providing power to the other internal components while enabling the mobile device 100 to be portable. Further, the internal components 200 can additionally include one or more sensors 228. All of the internal components 200 can be coupled to one another, and in communication with one another, by way of one or more internal communication links 232 (e.g., an internal bus).

Further, in the present embodiment of FIG. 2, the wireless transceivers 202 particularly include a cellular transceiver 203 and a Wi-Fi transceiver 205. More particularly, the cellular transceiver 203 is configured to conduct cellular communications, such as 3G, 4G, 4G-LTE, vis-à-vis cell towers (not shown), albeit in other embodiments, the cellular transceiver 203 can be configured to utilize any of a variety of other cellular-based communication technologies such as analog communications (using AMPS), digital communications (using CDMA, TDMA, GSM, iDEN, GPRS, EDGE, etc.), and/or next generation communications (using UMTS, WCDMA, LTE, IEEE 802.16, etc.) or variants thereof.

By contrast, the Wi-Fi transceiver 205 is a wireless local area network (WLAN) transceiver 205 configured to conduct Wi-Fi communications in accordance with the IEEE 802.11(a, b, g, or n) standard with access points. In other embodiments, the Wi-Fi transceiver 205 can instead (or in addition) conduct other types of communications commonly understood as being encompassed within Wi-Fi communications such as some types of peer-to-peer (e.g., Wi-Fi Peer-to-Peer) communications. Further, in other embodiments, the Wi-Fi transceiver 205 can be replaced or supplemented with one or more other wireless transceivers configured for non-cellular wireless communications including, for example, wireless transceivers employing ad hoc communication technologies such as HomeRF (radio frequency), Home Node B (3G femtocell), Bluetooth and/or other wireless communication technologies such as infrared technology. Thus, although in the present embodiment the mobile device 100 has two of the wireless transceivers 203 and 205, the present disclosure is intended to encompass numerous embodiments in which any arbitrary number of wireless transceivers employing any arbitrary number of communication technologies are present.

Example operation of the wireless transceivers 202 in conjunction with others of the internal components 200 of the mobile device 100 can take a variety of forms and can include, for example, operation in which, upon reception of wireless signals, the internal components detect communication signals and the transceivers 202 demodulate the communication signals to recover incoming information, such as voice and/or data, transmitted by the wireless signals. After receiving the incoming information from the transceivers 202, the processor portion 204 formats the incoming information for the one or more output devices 208. Likewise, for transmission of wireless signals, the processor portion 204 formats outgoing information, which can but need not be activated by the input devices 210, and conveys the outgoing information to one or more of the wireless transceivers 202 for modulation so as to provide modulated communication signals to be transmitted. The wireless transceiver(s) 202 conveys the modulated communication signals by way of wireless (as well as possibly wired) communication links to other devices.

Depending upon the embodiment, the output devices 208 of the internal components 200 can include a variety of visual, audio and/or mechanical outputs. For example, the output device(s) 208 can include one or more visual output devices 216, such as the display screen 102 (e.g., a liquid crystal display and/or light emitting diode indicator(s)), one or more audio output devices 218 such as a speaker, alarm and/or buzzer, and/or one or more mechanical output devices 220 such as a vibrating mechanism. Likewise, the input devices 210 of the internal components 200 can include a variety of visual, audio and/or mechanical inputs. By example, the input device(s) 210 can include one or more visual input devices 222 such as an optical sensor (for example, a camera lens and photosensor), one or more audio input devices 224 such as a microphone, and one or more mechanical input devices 226 such as a flip sensor, keyboard, keypad, selection button, navigation cluster, input surface (e.g., touch sensitive surface associated with one or more capacitive sensors), motion sensor, and switch. Operations that can actuate one or more of the input devices 210 can include not only the physical pressing/actuation of buttons or other actuators, and physically touching or gesturing along touch sensitive surfaces, but can also include, for example, opening the mobile device 100 (if it can take on open or closed positions), unlocking the mobile device 100, moving the mobile device 100 to actuate a motion, moving the mobile device 100 to actuate a location positioning system, and operating the mobile device 100.

As mentioned above, the internal components 200 also can include one or more of various types of sensors 228. The sensors 228 can include, for example, proximity sensors (e.g., a light detecting sensor, an ultrasound transceiver or an infrared transceiver), touch sensors (e.g., capacitive sensors associated with the input surface 104 that overlay the display screen 102 of the mobile device 100), altitude sensors, and one or more location circuits/components that can include, for example, a Global Positioning System (GPS) receiver, a triangulation receiver, an accelerometer, a tilt sensor, a gyroscope, or any other information collecting device that can identify a current location or user-device interface (carry mode) of the mobile device 100. While the sensors 228 are for the purposes of FIG. 2 considered as distinct from the input devices 210, various sensors 228 (e.g., touch sensors) can serve as input devices 210, and vice-versa. Additionally, while in the present embodiment the input devices 210 are shown to be distinct from the output devices 208, it should be recognized that in some embodiments one or more devices serve both as input device(s) and output device(s). In the present embodiment in which the display screen 102 is employed, the touch screen display can be considered to constitute both one of the visual output devices 216 and one of the mechanical input devices 226.

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. In some embodiments, the memory portion 206 can be integrated with the processor portion 204 in a single device (e.g., a processing device including memory or processor-in-memory (PIM)), albeit such a single device will still typically have distinct portions/sections that perform the different processing and memory functions and that can be considered separate devices. The data that is stored by the memory portion 206 can include, but need not be limited to, operating systems, applications, and informational data.

Each operating system includes executable code that controls basic functions of the mobile device 100, such as interaction among the various components included among the internal components 200, communication with external devices via the wireless transceivers 202 and/or the component interface 212, and storage and retrieval of applications and data, to and from the memory portion 206. Each application includes executable code that utilizes an operating system to provide more specific functionality, such as file system service and handling of protected and unprotected data stored in the memory portion 206. Such operating system and/or application information can include software update information (which can be understood to potentially encompass update(s) to either application(s) or operating system(s) or both). As for informational data, this is non-executable code or information that can be referenced and/or manipulated by an operating system or application for performing functions of the mobile device 100.

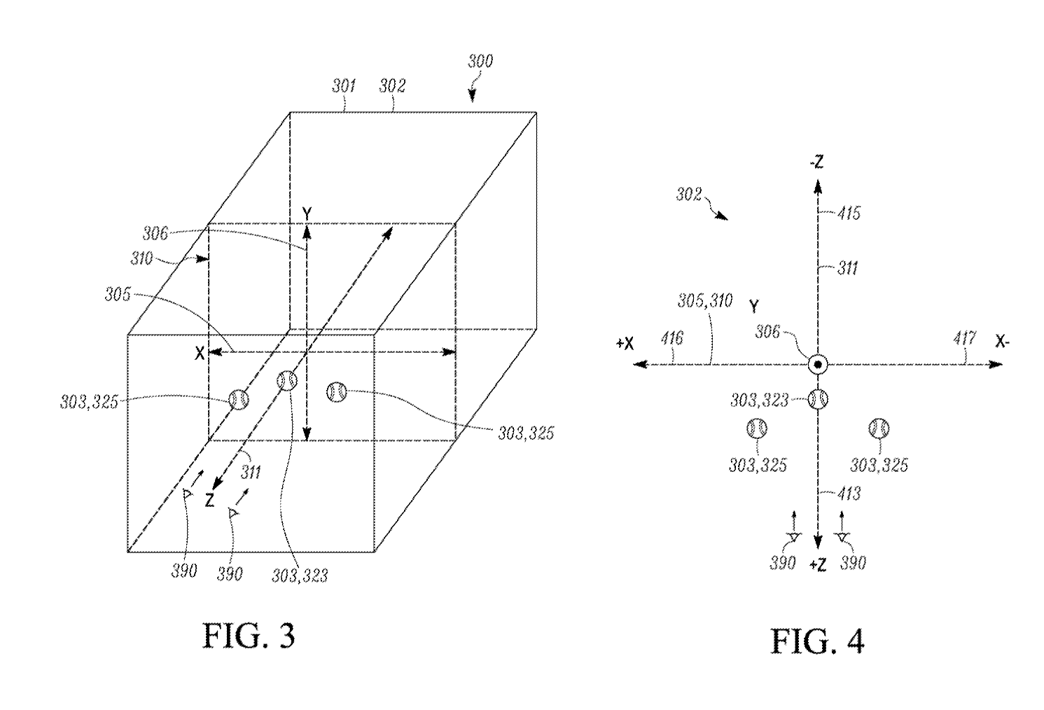

FIG. 3 depicts a virtual space 300 that is intended to illustrate a world coordinate system 301 and a camera coordinate system 302, which are utilized to provide an example of a stereoscopic view (user perceived three-dimensional (3D) view) of object images 303 relative to the display screen 102 of the mobile device 100. The object images 303 can be representative of various objects from programs/applications configured to allow for the manipulation of objects, such as mapping programs, mobile applications/games, drawing programs, computer aided drafting (CAD), computer aided 3D modeling, 3D movies, 3D animations, etc. In the Figures, the object images 303 are illustrated as spheres, although in other embodiments, the object images 303 can include various other shapes and sizes. Further, the object images 303 can include one or more primary object images 323 and one or more secondary object images 325. The primary object images 323 are the object images 303 that are selected (selectable) by a user for intended manipulation, whereas the secondary object images 325 are not selected (selectable) by the user, but serve as reference objects that can be moved by the program in order to accomplish the appearance that the selected object image 323 has moved or is moving. For illustrative purposes, only one primary object image 323 and two secondary object images 325 have been provided in the Figures, although in other embodiments additional object images 303 can also be included (or perhaps only two object images are present). The object images 303 can appear in various forms, such as objects, text, etc., and can be linked to numerous other objects, files, etc. In the present embodiments, each object image 303 is represented by a sphere, which can further be identified with coloring, graphics, etc. In addition, the object images 303 can be shown with a thickness to provide spatial depth, via the stereoscopic enhanced display screen 102.

With further reference to FIG. 3, the coordinates in the world coordinate system 301 are based on coordinates established about the earth, such as the North and South Poles, sea level, etc. Each object image 303 has a particular world coordinate position. If the position of the primary object image 323 is modified by a user, its world coordinate system position is changed, while the position of the secondary object images 325 would remain unchanged. In contrast, the coordinates in the camera coordinate system 302 are based on the view in front of a user's eyes 390, which can change without modifying the actual position of object images 303 in the world coordinate system 301.

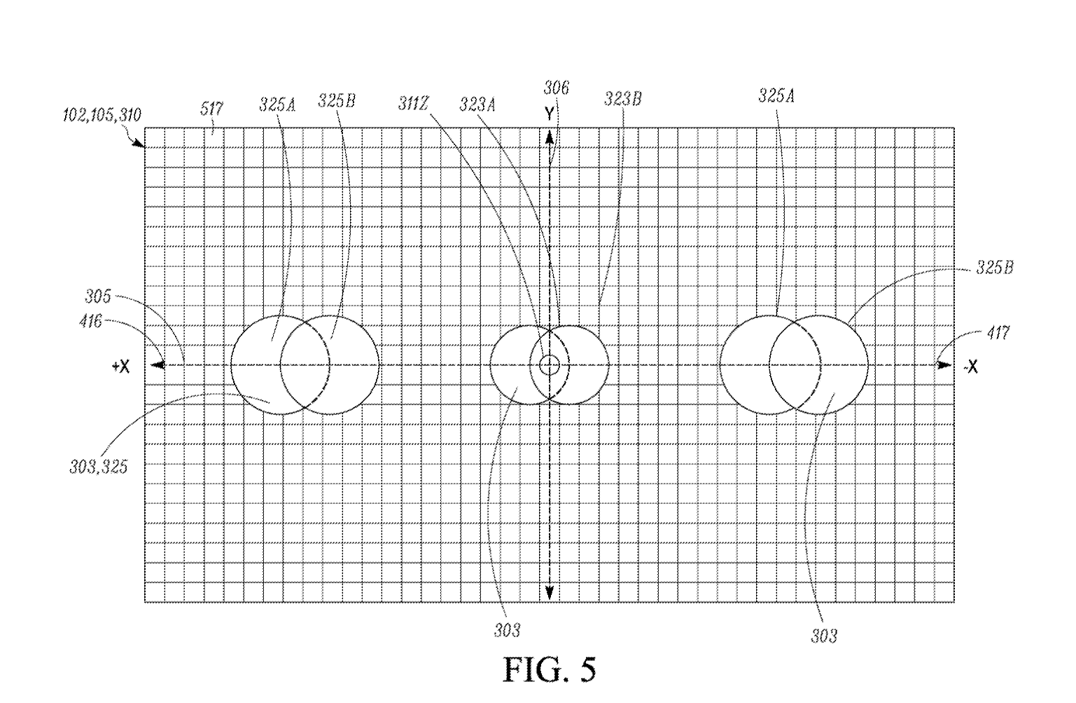

As will be discussed with reference to additional Figures, the object images 303 can be manipulated in various manners to reorient the object images 303 relative to each other and the display 102. The manipulations are generally initiated by a user performing a gesture on the display screen 102, such as touching the display screen 102 with one or more fingers at the point on the display screen where the object image 303 appears. However, in at least some embodiments, the manipulations can be performed through other input methods, such as through the use of a mechanical pointing device, voice commands, etc. Through the manipulation of the object images 303 at the display screen 102, a user can re-orient the object images 303 in a stereoscopic view to zoom in or zoom out on particular object images 303. In addition, a grid 517 (FIG. 5) can be provided on the display screen 102 that is configured to deform when contacted by one or more of the object images 303, such as the primary object image 323, as shown herein.

To enhance a user experience during a manipulation, the primary object image 323 is displayed fixed in the camera coordinate system 302, while the secondary object images 325 move relative to the primary object image 323. In this manner, the primary object image 323 appears to stay situated close to the point on the display screen 102 where the user is selecting it, while the secondary object images 325 appear to move away from their original positions. Once the primary object image 323 is manipulated to a desired location relative to the secondary object images 325, the view as seen by the user can be revised to show that the secondary object images 325 remain in their original world coordinate system positions, while the primary object image 323 has been moved to a new world coordinate system position. The world coordinate system 301 and camera coordinate system 302 can be aligned or misaligned with each other at different times. For simplicity, the arrangement of object images 303 in the virtual space 300 of FIG. 3 is shown with the world coordinate system 301 and the camera coordinate system 302 in alignment, wherein an X axis 305, a Y axis 306, and a Z axis 311 are provided.

Referring still to FIG. 3, a zero-plane 310 is provided that is intended to coincide with the physical plane 105 (FIG. 1) of the display screen 102. The zero-plane 310 is coincident with the X-Y plane (created by the X axis 305 and Y axis 306) of the camera coordinate system 302 and only exists in the camera coordinate system 302. In at least some embodiments, the zero-plane 310 can also be coincident with the X-Y plane of the world coordinate system 301. For clarification, FIG. 3 does not depict a user display screen view seen by a user, but rather is provided to better illustrate the positioning of the object images 303 in the virtual space 300 relative to the zero-plane 310.

It should be noted that, as the zero-plane 310 is positioned at the display screen 102, all physical touching (selection) occurs at the zero-plane 310, regardless of the appearance of the object images 303 to the user viewing the display screen 102. As such, in some instances, it will appear, at least in the Figures, that the user is not touching a portion of the primary object image 323, as the primary object image 323 will be shown along the Z axis 311 at a point away from the touching point on the display at the zero-plane 310. Further, in at least some embodiments, it is the intent that the positioning of the primary object image 323 is maintained at least partially at or about the zero-plane 310 so as to provide an intuitive touch point for the user. This can be particularly useful when a stereoscopic view is present, as one or more of the object images 325 can appear to be situated where a user cannot touch, such as behind or in front of the display screen 102. In at least some embodiments discussed herein, the object images 325 do not remain tethered to the zero-plane 310 during the touch action by the user, but the object images 325 can be moved as a group into a position that maintains their spatial relationship while placing the primary object image 323 at or near the zero-plane 310. Further, in at least some embodiments, the object images 325 are not tethered to the zero-plane 310 although they do return to a position about the zero-plane after a user has ceased to touch the display screen 102, without additional action taken by the user.

Referring to FIG. 4, which is a top view of the virtual space 300 shown in FIG. 3, the layout of the object images 303 in the X-Z plane is depicted. The Y axis 306 can be assumed to be extending into and out of the page. FIG. 4 does not depict an actual user display screen view seen by a user, but rather provides a view of the object images 303 in virtual space 300, relative to the zero-plane 310, as if a user was looking down along the Y axis 306 onto the virtual space 300 and a top edge of the display screen 102 (assumed to be along the X axis 305). The actual view of a user's eyes 390 would be approximately in the direction of the Z axis 311. As seen in FIG. 4, the Z axis 311 is additionally identified as having a +Z axis portion 413 and a −Z axis portion 415, as well as a +X portion 416 and a −X portion 417. As viewed by the user's eyes 390, the object images 303 positioned along the +Z axis portion 413 of the X-Z plane are displayed to appear in front of the display screen 102. In contrast, object images 303 that are situated along the −Z axis portion 415 of the X-Z plane are displayed to appear behind the display screen 102. The various X, Y, Z axes 305, 306, and 311, as well as the zero-plane 310 of the virtual space 300, as shown in FIGS. 3 and 4, provide a reference framework that is intended to be illustrative of a similar example framework employed by the remaining Figures.

Referring to FIG. 5, a display of the object images 323, 325 on the display screen 102 of the mobile device 100 is provided along with a reference grid 517. The object images 303 are intended to be displayed in the virtual space 300 that includes the X axis 305, Y axis 306, and Z axis 311, with the Z axis 311 extending perpendicular to the display screen 102 from the X-Y origin. In addition, the zero-plane 310 is coincident with the display screen 102 in the X-Y plane. As discussed above, displaying the object images 303 in the virtual space 300 can provide a stereoscopic appearance. More particularly, the stereoscopic appearance of the object images 303 in front of, at, or behind the display screen 102 is provided by displaying a pair of images to represent each object image 303, so that the left eye of the user sees one and the right eye sees the other. In this regard, even though the user is provided with a display of multiple images, they will only recognize a single object image representative of each pair of images. For example, a primary object image 323A and a primary object image 323B can be displayed by the display screen 102, wherein the primary object images 323A and 323B are identical to each other. Further, the primary object images 323A and 323B are positioned centered along the X axis 305 and are adjacent to, or at least partially overlapping, each other so as to each have a center that is at a different position on the X axis 305. As shown in FIG. 5, the primary object image 323A is overlapped by the primary object image 323B. A greater overlap of the primary object image 323A by the primary object image 323B results in the primary object image 323 being displayed closer to the zero-plane 310 and X axis 305. The secondary object images 325A are overlapped by the secondary object images 325B. A lesser overlap of the secondary object image 325A by the secondary object image 325B results in the secondary object image 325 being displayed farther away from the zero-plane 310 and X axis 305.

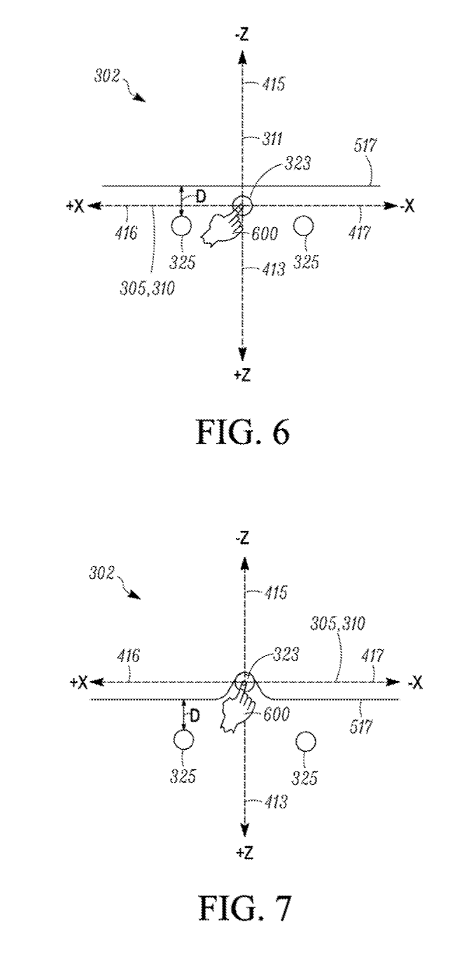

FIG. 6 illustrates the position of the object images 323, 325 in the X-Z plane of the virtual space 300, after a user has selected (e.g., via touch with a portion of the user's hand 600) the primary object image 323 for a period of time. More particularly, when a user touches the point of the display screen 102 where the primary object image 323 appears, the object images shift to center the primary object image 323 at the zero-plane 310 (X axis 305) for intuitive subsequent selection of the primary object image 323 by the user. As seen in FIG. 6, the secondary object images 325 are positioned a distance D away from the grid 517 along the Z axis 311.

Referring now to FIG. 7, an example modified view of FIG. 6 is provided that illustrates the position of the object images 323, 325 after a user has selected the primary object image 323 for a period of time. More particularly, when a user touches the point of the display screen 102 at the zero-plane 310 where the primary object image 323 appears, using a unique programmed touch (e.g., one finger touch) a PUSH action command is initiated by the mobile device 100 and processed. Various selection methods can be used to discern between a PUSH action command and another action command such as a PULL action command, by using for example, one finger touch for a PUSH action and a two finger touch for a PULL action.

When a PUSH action command is received by the processor 204 of the mobile device 100, the object image 323 can be repositioned in the world coordinate system 301. In addition, to provide the appearance that the primary object image 323 is moving inwards of the display screen 102 under the pressure of the touch, the camera coordinate system 302 shifts to display the secondary object images 325 moving away from the primary object image 323. Further, as the secondary object images 325 are moved down the +Z axis portion 413, away from the primary object image 323, they can in at least some embodiments, be enlarged so that they appear further out of the display screen 102 towards the user. Meanwhile, the primary object image 323 remains pinned to the zero-plane 310 and in at least some embodiments is reduced in size, while in other embodiments it can remain consistent in size. Further, the grid 517 shifts along with the secondary object images 325 to remain at a consistent distance D therefrom. Although the majority of the grid 517 remains in a planar shape and follows the secondary object images 325, the portion of the grid 517 that is adjacent to the primary object image 323 can deform around the primary object image 323 to further enhance the stereoscopic appearance, as shown in FIG. 7. In at least some embodiments, if the primary object image 323 is pushed far enough, the primary object image 323 can be shown as though it has passed through the grid 517 altogether and subsequently positioned on the other side of the grid 517.

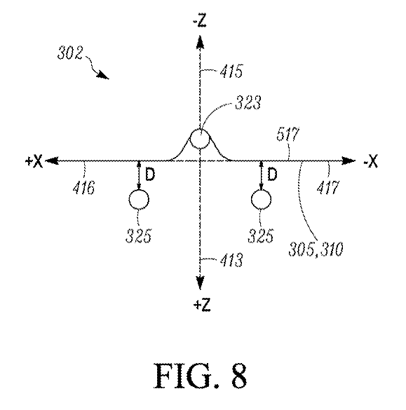

FIG. 8 is a view of FIG. 7 after the user has removed their finger, ceasing the touch selection of the primary object image 323. Although the positioning of the object images 323, 325 can remain static once the user has ceased touching the display screen 102, in at least some embodiments, as shown in FIG. 8, the object images 303 can shift as a group (maintaining their spatial relationships with each other in the world coordinate system 301) in the direction of the −Z axis portion 415. In this manner, when the primary object image 323 is released (removal of touch), it shifts to the −Z axis 415, and the secondary object images 325 shift back to their initial position adjacent the zero-plane 310 along the +Z axis portion 413, along with the undistorted portion of the grid 517. This movement is a result of a shift in the camera coordinate system 302 back to its original position before the PUSH action occurred.

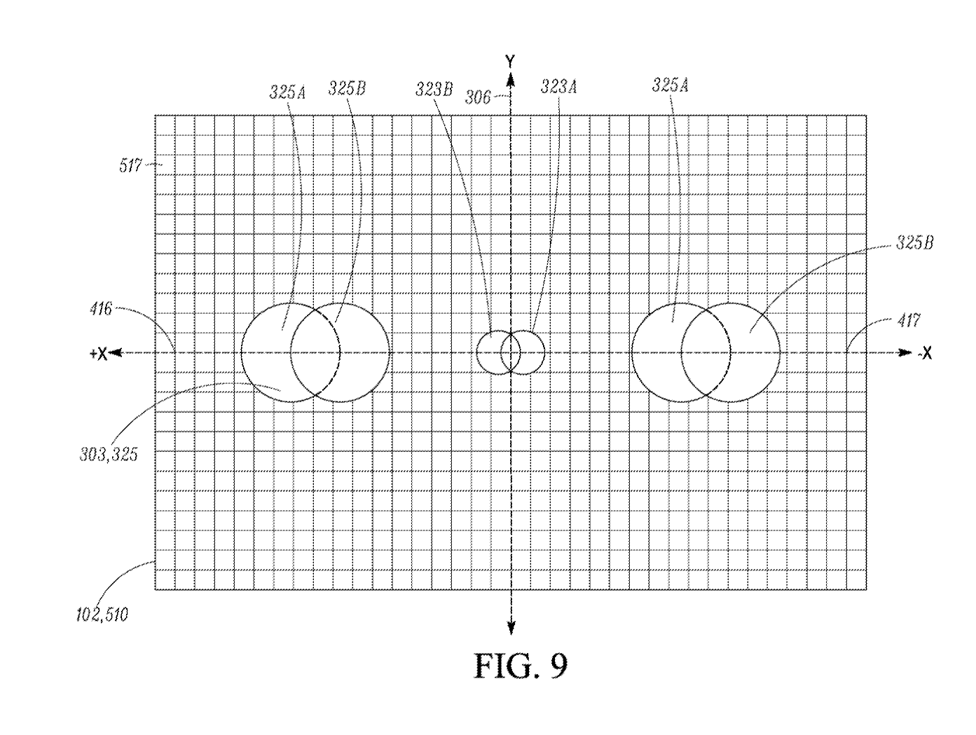

Referring now to FIG. 9, the display of the object images 323, 325 on the display screen 102 of the mobile device 100 is provided, along with a reference grid 517. Similar to FIG. 5, the primary and secondary object images 323, 325 each include a pair of overlapping images. As seen in FIG. 9, the primary object images 323A, 323B have diminished in size relative to FIG. 5 as a result of the displacement of the primary object image 323 further into the screen (along the −Z axis) and away from the user and zero-plane 310. In addition, as the primary object images 323A, 323B have been displaced across the X axis 305 and into the −Z axis 415, the primary object image 323A now overlaps the primary object image 323B. A decreased overlap of the primary object image 323B by the primary object image 323A results in the primary object image 323 being displayed farther from the zero-plane 310 and X axis 305. The secondary object images 325A remain overlapped by the secondary object images 325B, as in FIG. 5. This is because their position remains on the +Z axis portion 413, same as in FIG. 5.

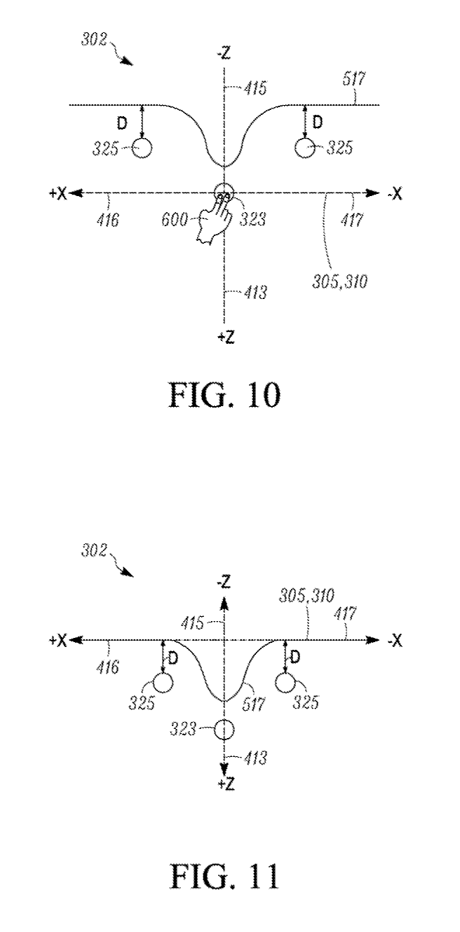

Referring now to FIG. 10, which provides a modified view of FIG. 6, wherein after the primary object image 323 has been centered at the zero-plane 310 in FIG. 6, a PULL action command is performed to reposition the object images 323, 325. In a PULL action, the user selects the primary object image 323, similar to as discussed above, although a different unique programmed touch (e.g., two finger touch) is performed to signal a PULL action command to the processer 204. In a PULL action, the primary object image 323 is moved in the world coordinate system 301, but remains fixed in the camera coordinate system 302, while the secondary object images 325 remain fixed in the world coordinate system 301, but are displayed as moving in the camera coordinate system 302. More particularly, when the primary object image 323 is selected, the secondary object images 325 are shown moving from their original position in the +Z axis portion 413 of the X-Z plane across the zero-plane 310 to the −Z axis portion 415 of the X-Z plane. In addition, the grid 517 also moves along the −Z axis portion 415, remaining a distance D from the secondary object images 325. As seen in FIG. 10, a portion of the grid 517 remains tethered to its original location just below the primary object image 323 (as shown in FIG. 6), while the majority of the grid 517 maintains its planar shape. In this regard, the grid 517 has deformed to best illustrate the distancing of the primary object image 323 from the secondary object images 325.

FIG. 11 is a view of FIG. 10 after the user has removed their fingers, ceasing the touch selection of the primary object image 323. In at least some embodiments, as shown in FIG. 11, the object images 323, 325 can shift as a group (maintaining their spatial relationships with each other in the world coordinate system 301), this time in the direction of the +Z axis portion 413. In this manner, when the primary object image 323 is released (removal of touch), the secondary object images 325 shift back to their initial position adjacent the zero-plane 310 along the +Z axis portion 413. As the new position of the primary object image 323 is now fixed in the world coordinate system 301, it also shifts to the +Z axis portion 413 along with the grid 517. This movement is a result of a shift in the camera coordinate system 302, as described above.

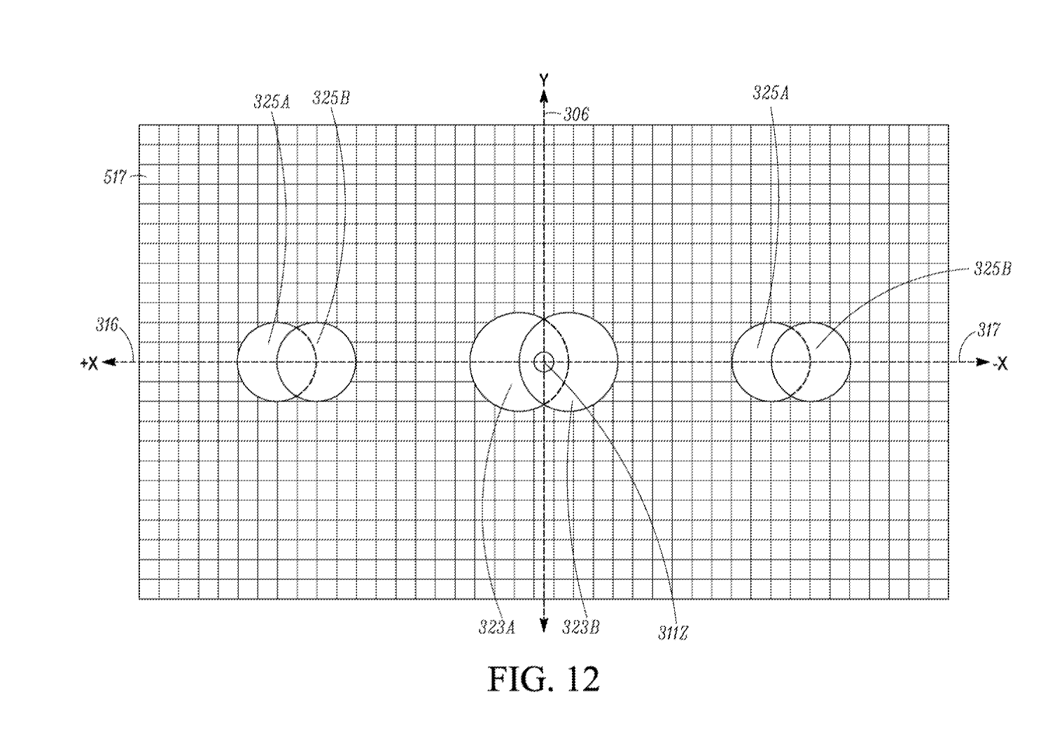

Referring to FIG. 12, the display of the object images 323, 325 on the display screen 102 of the mobile device 100 is provided, along with the reference grid 517. Similar to FIG. 5, the primary and secondary object images 323, 325 each include a pair of overlapping images. As seen in FIG. 12, the primary object images 323A, 323B have increased in size relative to FIG. 5 as a result of the displacement of the primary object image 323 further away from the zero-plane 310 (along the +Z axis) and closer to the user. In addition, as the primary object images 323A, 323B have been displaced further along the +Z axis portion 413, the primary object image 323B continues to overlap primary object image 323A. Further, as the primary object image 323 has moved further from the zero-plane 310 along the +Z axis portion 413, the overlap between the primary object images 323A, 323B has decreased. Decreasing the overlap of the primary object images 323A, 323B provides the illusion that the primary object image 323 is closer to the user and farther from the zero-plane 310. The secondary object images 325A remain overlapped by the secondary object images 325B, as in FIG. 5. This is because their position remains off the zero-plane 310.

For additional consideration with regard to the method and system encompassed herein, in at least some embodiments, the object images 303 can be selected and moved around relative to the grid 517, whether in a PULL position, PUSH position, or neither. Such movement of the object image 303 relative to the grid 517 can include deforming the grid portions as they are contacted by the object image, and undeforming portions of the grid as when they no longer contact the object image 303.

In various embodiments, the PULL and PUSH action can be accompanied by audio effects produced by the mobile device 100. In addition, various methods of highlighting of the object images 303 can be provided, such as varied/varying colors and opacity. For example, the primary object image 323 can be highlighted to differentiate it from the secondary object images 325, and/or the highlighting can vary depending on the position of the object images 303 relative to the zero-plane 310 or another point.

Further, the user's view of the object images 303 can be manipulated by changing the camera view (e.g., viewing angle) provided at the display screen 102. For example, a double-tap on the display screen 102 can unlock the current camera view of the object images 303. Once unlocked, the current camera view of the object images 303 can be changed by a movement of a user's touch across the display screen 102. In addition, the camera view can also be modified by using a pinch-in user gesture to zoom in and a pinch-out user gesture to zoom out. In this manner, the user can rotate the object images 303 in the virtual space 300 to provide an improved view of object images 303 that can, for example, appear an extended distance from the zero-plane 310, or are shown underneath the grid 517 and would otherwise be difficult to see without interference from other object images 303 or portions of object images 303.

It should be noted that prior to, during, or after a view is presented, interaction hints (e.g., text) can be displayed to assist the user by providing specific options and/or instructions for their implementation. In addition, the views provided in the Figures are examples and can vary to accommodate various types of object images as well as various types of mobile devices. Many of the selections described herein can be user selectable only and/or time-based for automated actuation.

In view of the many possible embodiments to which the principles of the method and system encompassed herein may be applied, it should be recognized that the embodiments described herein with respect to the drawing Figures are meant to be illustrative only and should not be taken as limiting the scope of the method and system encompassed herein. Therefore, the method and system as described herein contemplates all such embodiments as may come within the scope of the following claims and equivalents thereof.

We claim:

1. A method of manipulating viewable objects comprising:
providing a touch screen display capable of stereoscopic displaying of object images, wherein a zero-plane reference is positioned substantially coincident with the physical surface of the display;
displaying on the touch screen a first object image and one or more second object images, wherein the first object image and one or more second object images are displayed to appear at least one of in front of, at, or behind the zero-plane;
receiving a first input at the touch screen at a location substantially corresponding to an apparent position of the first object image; and
modifying the displaying on the touch screen so that the first object image and the one or more second object images appear to move towards one of outward in front of the touch screen or inward behind the touch screen in a stereoscopic manner.

2. The method of claim 1, further including modifying the displaying on the touch screen so that the one or more second object images appear to move in a direction substantially opposite the first object image.

3. The method of claim 2, wherein upon cessation of the first input at the touch screen, at least one of the first object image and the one or more second object images are shifted to appear adjacent to the zero-plane while the first object image and the one or more second object images maintain their spatial relationship relative to each other during the shifting.

4. The method of claim 1, further including modifying the displaying of the first object image, such that the displayed size of the first object image is either increased or decreased during the receiving of the first touch input.

5. The method of claim 1, further including modifying the displaying of the one or more second object images, such that the displayed size of the one or more second object images is either increased or decreased during the receiving of the first touch input.

6. The method of claim 1, further including modifying the displaying of the first object image, such that a first scale of the first object image changes in relation to a second scale of the one or more second object images and simultaneously modifying the displaying of the one or more second object images, such that the second scale of the one or more second object images changes in relation to the first scale of the first object image.

7. The method of claim 1, wherein modifying the displaying on the touch screen further includes maintaining the appearance that at least one of the first object image and the one or more second object images are positioned adjacent to the display screen, during the positioning of the other of the first object image and the one or more second object images.

8. The method of claim 1, wherein the one or more second object images include two or more object images, and wherein the one or more second object images each appear to a user to move an equal distance relative to the zero-plane.

9. The method of claim 8, further including detecting and processing a push action command when receiving the first input at the touch screen and modifying the display on the touch screen so that the first object image appears to move behind the touch screen and the at least one second object appears to move in front of the touch screen.

10. The method of claim 8, further including detecting and processing a pull action command when receiving the first input at the touch screen and modifying the display on the touch screen so that the first object image appears to move in front of the touch screen and the at least one second object appears to move behind the touch screen.

11. The method of claim 8, further including displaying a grid substantially coincident with the zero-plane.

12. The method of claim 11, further including modifying the appearance of the grid by distorting the planar grid at a portion of the grid that is adjacent to the first object image, such that a contour is displayed that extends from the remaining planar portion to a loop that is tethered to a point adjacent to the primary object image; and
tethering the non-distorted planar portion of the grid to a fixed distance from the one or more second object images.

13. The method of claim 8, further including processing at a processor a command to modify the displayed view of the first object image and the one or more second object images; and
modifying the displaying of the first object image and the one or more second object images so that the displayed viewing position of the first object image and the one or more second object images is shifted, wherein the first object image and the one or more second object images maintain their spatial relationship relative to each other during the modification of the viewing angle.

14. The method of claim 8, further including modifying the displayed view of the first object image and the one or more second object images upon at least one of a command and a cessation of a selection; and
modifying the displaying of the first object image and the one or more second object images so that the displayed view of the one or more second object images includes the one or more second object images at their original position relative to the zero-plane, subsequent to a change in the distance between the first object image and the one or more second object images, wherein the first object image and the one or more second object images maintain their spatial relationship relative to each other.

15. A method of manipulating viewable objects displayed on a touch screen comprising:
displaying a first object image and one or more second object images in a perceived virtual space provided by a touch screen display configured to provide a stereoscopic display of the first object image and one or more second object images;
positioning the first object image at or adjacent to a zero-plane that intersects the virtual space and is substantially coincident with the surface of the touch screen display;
sensing a selection of the first object image; and
modifying the perceived position of at least one of the first object image and the one or more second object images, such that at least one of the first object image and the one or more second object images are relocated to appear a distance from their original displayed location.

16. The method of claim 15, tethering the apparent position of at least one of the first object image and the one or more second object images to the zero-plane, while the other of the first object image and the one or more second object images appears to move away from the zero-plane.

17. The method of claim 15, wherein the selection of the first object image results in a display of both the first object image and the one or more second object images appearing to simultaneously move in opposite directions in the virtual space.

18. The method of claim 17, wherein upon cessation of sensing the selection, the first object image and the one or more second object images are shifted in the virtual space such that one of the first object image and the one or more second object images appears adjacent to the zero-plane, and wherein the spatial relationship between the first object image and the one or more second object images remains constant until a subsequent selection is sensed.

19. The method of claim 15, wherein the one or more second object images include two or more object images, and wherein the two or more second object images move in unison relative to the zero-plane.

20. A mobile device comprising:
a touch display screen capable of providing a stereoscopic view of a plurality of object images,
wherein the object images are configured to appear to a user viewing the display to be situated in a three-dimensional virtual space that includes a world coordinate system and a camera coordinate system,
wherein the camera coordinate system includes an X axis, Y axis, and Z axis with a zero-plane coincident with an X-Y plane formed by the X axis and Y axis, and the zero-plane is substantially coincident with the surface of the display screen, and
wherein at least one of the object images is displayed so as to appear at least partly coincident with the zero plane, such that it is selected by a user for performing a function, and at least one of the other object images appears positioned at least one of inward and outward of the zero plane and is not selected to perform a function; and
a processor that is programmed to control the display of the plurality of object images on the display screen.
